(19) United States
(12) Patent Application Publication
(10) Pub. No.: US 2012/0044360 A1
(43) Pub. Date: Feb. 23, 2012

(54) DETERIORATION SENSING APPARATUS FOR DISPLAY DEVICE

(75) Inventors: Sang Hyun CHA, Seoul (KR); Youn Joong LEE, Seoul (KR); Gyu Hyeong CHO, Daejeon (KR); Jin Yong JEON, Daegu (KR); Jun Hyeok YANG, Daegu (KR); Hyun Sik KIM, Jeollabuk-do (KR); Jae Shin LEE, Gyunggi-do (KR)

(73) Assignees: KOREA ADVANCED INSTITUTE OF SCIENCE AND TECHNOLOGY, Daejeon (KR); SAMSUNG ELECTRO-MECHANICS CO., LTD, Gyunggi-do (KR)

(21) Appl. No.: 13/093,918

(22) Filed: Apr. 26, 2011

(30) Foreign Application Priority Data
Aug. 20, 2010 (KR) 10-2010-0080662

(51) Int. Cl. H04N 17/02

(52) U.S. Cl. 348/189; 348/E17.004

(57) ABSTRACT

Disclosed is a deterioration sensing apparatus for a display device, capable of rapidly sensing deterioration by pre-charging a sensing voltage in adjacent pixels while a deterioration of a single pixel is sensed in a display device having a plurality of pixels, in, particular, an organic light emitting diode panel.

### CROSS-REFERENCE TO RELATED APPLICATIONS

This application claims the priority of Korean Patent Application No. 10-2010-0080662 filed on Aug. 20, 2010, in the Korean Intellectual Property Office, the disclosure of which is incorporated herein by reference.

### BACKGROUND OF THE INVENTION

1. Field of the Invention

The present invention relates to a deterioration sensing apparatus for a display device, and more particularly, to a deterioration sensing apparatus for a display device capable of rapidly sensing deterioration by pre-charging a sensing voltage in an adjacent pixel while a deterioration of a single pixel is sensed in a display device having a plurality of pixels, in particular, an organic light emitting diode panel.

2. Description of the Related Art

Generally, a display device has been used for electronic devices in order to display images desired by a user, operational states of the electronic devices, and the like.

In the case of display devices, there exist a cathode ray tube (CRT) type display device that is a long-established device, a general display device such as a liquid crystal display (LCD) that has a smaller thickness than that of the PET type display device, and a display device adopting organic light emitting diodes (i.e., an OLED display). The OLED display is capable of achieving a reduction In thickness and weight of approximately ⅓, while remarkably increasing an image-quality reaction rate, as compared to those of the liquid crystal display, in order to adapt to the increased demand for large display devices having a small volume.

The OLED display is classified into a passive type and an active type according to a driving mode thereof. In particular, the active type OLED display, capable individually controlling pixels, the minimum units forming a screen, is in widespread use.

The OLED display exhibits excellent performance in terms of image quality, thickness, weight, brightness, power consumption, and the like, as compared to the existing liquid crystal display.

However, an OLED display as well as the liquid crystal display, needs Lo display an image desired by a user on a screen thereof; however, such a display may fail to display images having uniform luminance due to a deterioration phenomenon in which luminance of light is gradually lowered over time in response to the same data signal.

Therefore, there is a need to sense a deterioration in each pixel of the display device and appropriately compensate for each of the deteriorated pixels. However, sensing a deterioration in each pixel is a time-consuming operation.

### SUMMARY OF THE INVENTION

An aspect of the present invention provides a deterioration sensing apparatus for a display device capable of rapidly sensing deterioration by pre-charging a sensing voltage in an adjacent pixel while a deterioration of a single pixel is sensed in a display device having a plurality of pixels, in particular, an organic light emitting diode panel.

There is provided a deterioration sensing apparatus, including: a power supply unit transferring a preset current for deterioration sensing: a pixel unit including a plurality of pixel groups adjacent to each other, each of the plurality of pixel units receiving the current for deterioration sensing from the power supply unit; a transfer unit including a plurality of switch groups corresponding to each of the plurality of pixel groups, and transferring the current for deterioration sensing from the power supply unit to each pixel group of the plurality of pixel groups to sequentially sense a voltage, wherein, while transferring the current for deterioration sensing to a corresponding pixel group of the plurality of pixel groups to thereby sense a voltage, the transfer unit previously transfers the current for deterioration sensing to a next pixel group adjacent to the corresponding pixel group; and an analog-digital converter sequentially detecting the voltage of the pixel groups receiving the current for deterioration sensing among the plurality of pixel groups in the pixel unit and converting the voltage into a digital signal.

Each of the plurality of pixel groups may have a red pixel, a green pixel, and a blue pixel.

The transfer unit may previously transfer the current for deterioration sensing, being transferred to the corresponding pixel unit of the plurality of pixel groups, to a pixel of the red, green and blue pixels of the next pixel group having the same color as a pixel of the red, green and blue pixels of the corresponding pixel group being supplied with the current for deterioration sensing therefrom.

Each of the plurality of switch groups of the transfer unit may include a plurality of switches transferring the current for deterioration sensing from the power supply unit to a corresponding pixel of the red, green and blue pixels, and previously transferring the current for deterioration sensing to the pixel of the next pixel group having the same color as the the pixel of the corresponding pixel group.

The analog-digital converter may convert the voltage of a pixel group of the plurality of pixel groups, initially supplied with the current for deterioration sensing through the transfer unit, into a digital signal, and convert a voltage difference between the pixel unit, supplied with the current for deterioration sensing after the pixel unit initially supplied with the current for deterioration sensing among the plurality of pixel groups, and the previous pixel unit thereof into a digital signal.

The transfer unit may previously transfer the current for deterioration sensing to the adjacent pixel group to the corresponding pixel group being supplied with the current for deterioration sensing therethrough, and then, charge or discharge the current for deterioration sensing to the adjacent pixel group.

Each of the red, green and blue pixels may be configured of an organic light emitting diode.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a diagram schematically showing the configuration of a deterioration sensing apparatus according to an exemplary embodiment of the present invention;

FIGS. 2A to 2C are diagrams showing operational examples of the deterioration sensing apparatus according to the exemplary embodiment of the present invention;

FIG. 3 is a diagram showing an example of voltage sensing of the deterioration sensing apparatus according to the exemplary embodiment of the present invention; and

FIG. 4A is a table showing a sensing time of a deterioration sensing apparatus according to the related art, and FIG. 4B is a table showing a sensing time of the deterioration sensing apparatus according to the exemplary embodiment of the present invention.

### DETAILED DESCRIPTION OF THE PREFERRED EMBODIMENT

Exemplary embodiments of the present invention will now be described in detail with reference to the accompanying drawings.

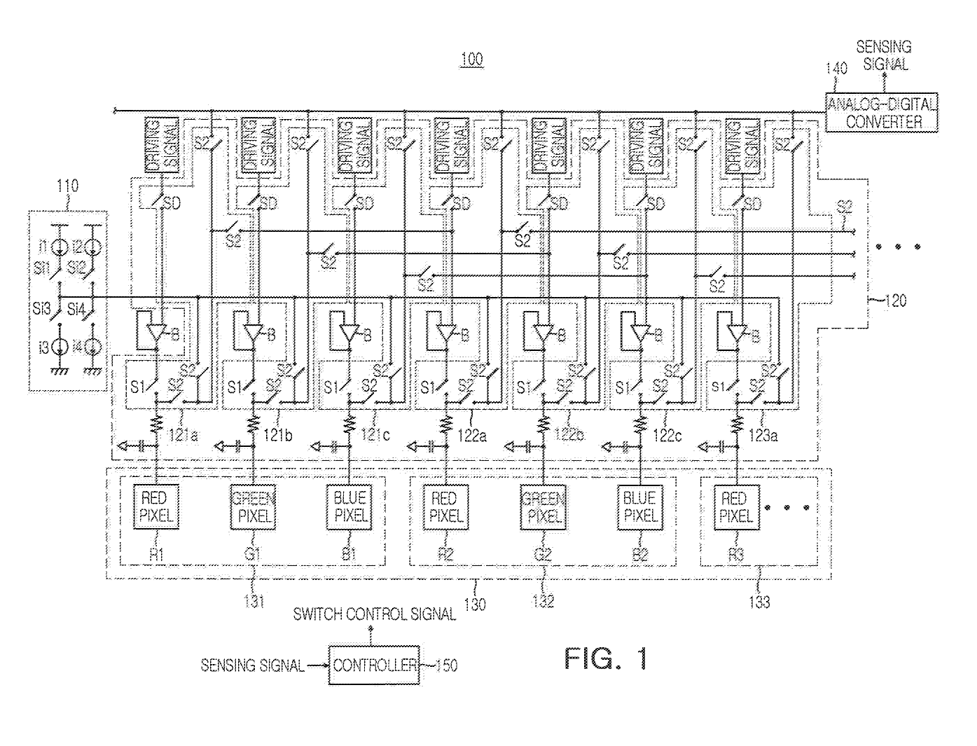

FIG. 1 is a diagram schematically showing the configuration of a deterioration sensing apparatus according to an exemplary embodiment of the present invention.

Referring to FIG. 1, a deterioration sensing apparatus 100, according to an exemplary embodiment of the present invention, maybe configured to include a power supply unit 110, a transfer unit 120, a pixel unit 130, an analog-converting unit 140, and a controller 150 controlling the transfer unit 120.

The power supply unit 110 may supply a preset current for deterioration sensing (hereinafter, a sensing current). The power supply unit 110, when transferring the sensing current to the pixel unit 130, may charge or discharge extra sensing current due to voltage differences between a plurality of pixel groups 131, 132, and 133 in the pixel unit 130. To this end, the power supply unit 110 may be configured to include R current sources i1, i2, i3, and i4 for charging and discharging, and switches Si1, Si2, Si3, and Si4 for switching charging and discharging paths.

The transfer unit 120 may be configured to include a plurality of switch groups 121a, 121b, 121c, 122a, 122b, 122c, and 123a. The plurality of switch groups 121a, 121b, 121c, 122a, 122b, 122c, and 123a correspond to a corresponding one of the plurality of pixel groups 131, 132, and 133. In this case, the pixel groups 131, 132, and 133 include respective sets of red, blue and green pixels R1, R2, R3, G1, G2, B1 and B2. The plurality of switch groups 121a, 121b, 121c, 122a, 122h, 122c, and 123a correspond to the red, green, blue, red, green blue and red pixels R1, G1, B1, R2, G2, B2, and R3, respectively. The above-mentioned red pixels R1, R2, and R3, the green pixels G1 and G2, and the blue pixels B1 and B2 may he configured of organic light emitting diodes.

Each of the plurality of switch groups 121a, 121b, 121c, 122a, 122b, 122c, and 123a, respectively corresponding to the the red, green, blue, red, green blue and red pixels R1, G1, B1, R2, G2, B2, and R3, transfers the sensing current to the corresponding pixel from the power supply unit 110. In this case, the sensing current may be previously transferred to an adjacent pixel of the corresponding pixel. That is, according to the related art, the sensing current is sequentially transferred to corresponding pixels. On the other hand, the deterioration sensing apparatus 100 according to the exemplary embodiment of the present invention transfers the sensing current to a corresponding pixel while transferring the sensing current to the next pixel, which is to he sensed for deterioration, in advance, so that the time it takes to sense deterioration (hereinafter, sensing time) may be shortened.

Therefore, each of the plurality of switch groups 121a, 121b, 121c, 122a, 122b, 122c, and 123a may include a plurality of switches S1 and S2 switching sensing-current transfer paths. In this case, the first switch S1 and the plurality of second switches S2 may be alternately switched in a single switch group. That is, in order to sense the deterioration of a corresponding pixel, the first switch Si may be turned on and the plurality of second switches S2 may be opened. Also, in order to transfer the sensing current to an adjacent pixel thereto, the first switch S1 may he opened and the plurality of second switches S2 may be turned on. Since a level of the sensing current may be small, a buffer B may be provided to facilitate the inflow of the current. The parasitic resistance component and the parasitic capacitance component of the transfer line transferring the sensing current to the pixels are shown. In addition, a switch SD for driving may be provided in order to transfer driving signals driving the pixels after or before the operation of sensing the deterioration of the pixels.

The deterioration of the corresponding pixel is sensed as voltage, which is in turn transferred to the analog-digital converter 140, and the analog-digital converter 140 converts it into a digital signal, which may be in turn transferred to the outside.

The controller 150 may provide a switch control signal, for sequentially operating the switches S1 and S2 of the switch groups 121a, 121b, 121c, 122a, 122b, 122c, and 123a, to the switches S1 and S2 of the switch groups 121a, 121b, 121c, 122a, 122h, 122c, and 123a. In addition, the controller 150 receives the sensing signal from the analog-digital converter 140, thereby determining the deterioration of pixels.

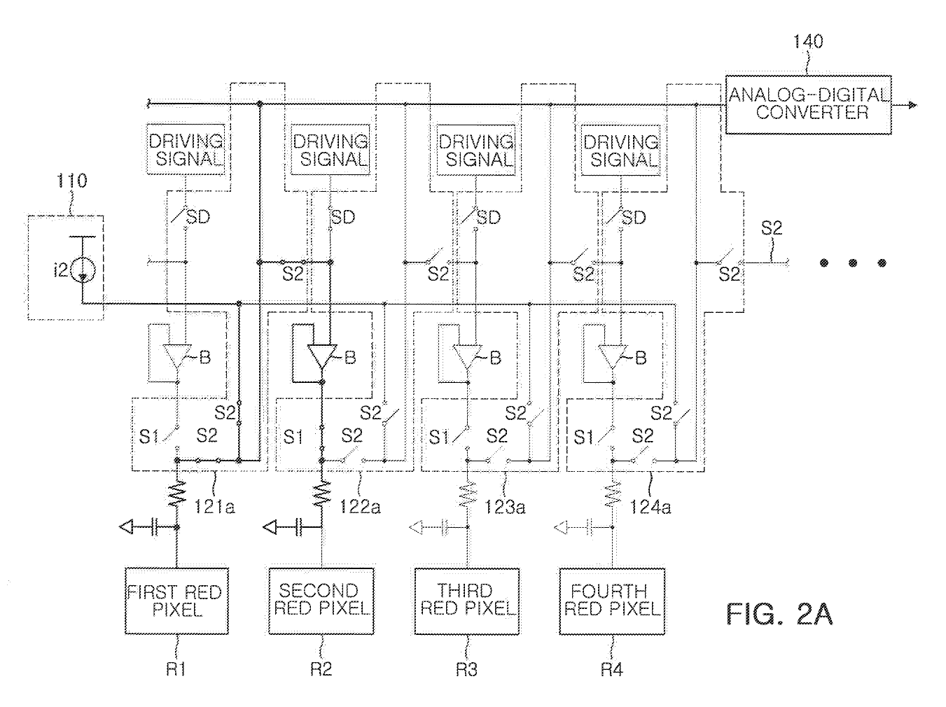

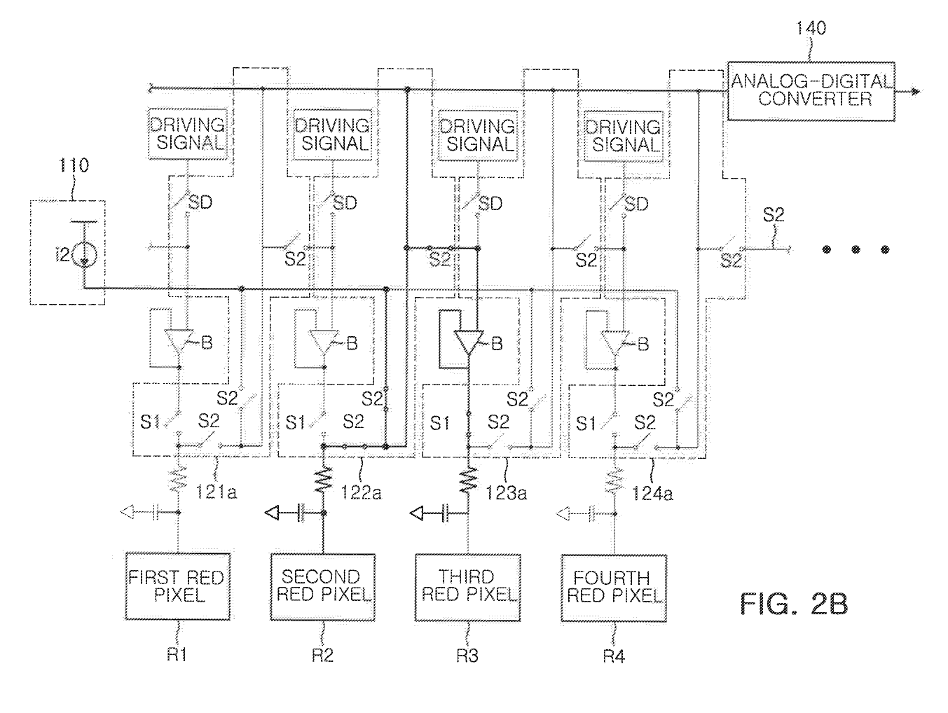

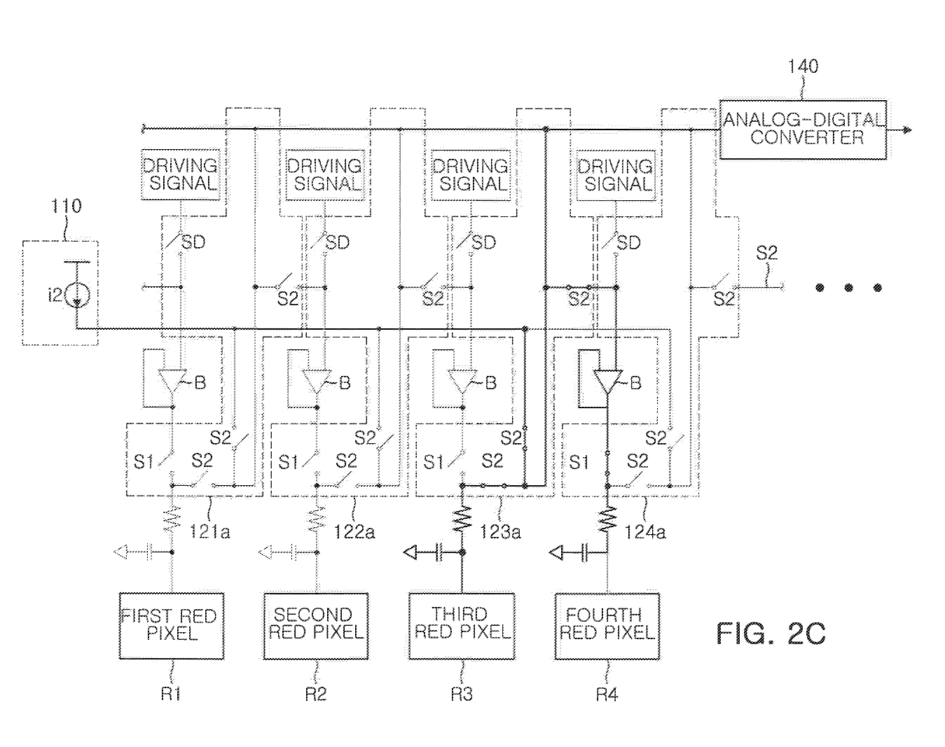

FIGS. 2A to 2C are diagrams showing operational examples of the deterioration sensing apparatus according to the exemplary embodiment of the present invention.

Referring to FIGS. 1 and 2A, the respective red pixels R1, R2, R3, and R4 of the plurality of pixel groups 131, 132, and 133 in the pixel unit 130 are illustrated as an example. Even in the case of the green pixel and the blue pixel, the operation is the same and there, the description of the operation of the green pixel and the blue pixel will be omitted.

First, the first switch Si of the switch group 121a for the first red pixel R1 is turned on and the plurality of second switches S2 are opened to sense the deterioration of the first red pixel R1. Thereafter, the first switch S1 is opened and the plurality of second switches S2 are turned on to previously charge the sensing current in the second red pixel R2 adjacent to the first red pixel R1. To this end, the first switch S1 of the switch group 122a for the second red pixel R2 is turned on.

Thereafter, referring to FIG. 2B, after the deterioration of the second red pixel R2 is sensed, the first switch S1 of the switch group 122a for the second red pixel R2 is opened and the plurality of second switches S2 are turned on, thereby previously charging the sensing current in the third red pixel R3 adjacent to the second red pixel R2. To this end, the first switch S1 of the switch group 123a for the third red pixel R3 is turned on.

Similarly, referring to FIG. 2C, after the deterioration of the third red pixel R3 is sensed, the first switch S1 of the switch group 123a for the third red pixel R3 is opened and the plurality of second switches S2 are turned on, thereby previously charging the sensing current in a fourth red pixel R4 adjacent to the third red pixel R3. To this end, the first switch S1 of the switch group 124a for the fourth red pixel R4 is turned on. Even in the case of the green pixel and the blue pixel, the above-mentioned operation is operated in the same manner and the above-mentioned operation may be sequentially made according to the number of pixels.

Meanwhile, the deterioration sensing voltage of the first red pixel R1 may be sensed as an absolute value, while the deterioration sensing voltages the second to fourth red pixels R2, R3, and R4 may be sensed as the relative values to the deterioration sensing voltage of the previous red pixels.

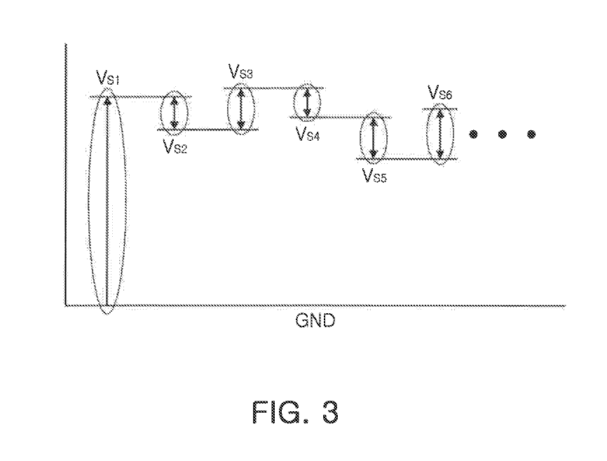

FIG. 3 is a diagram showing an example of voltage sensing of the deterioration sensing apparatus according to the exemplary embodiment of the present invention.

Referring to FIG. 3, when the deterioration voltage Vs1 of a pixel into which the current for deterioration sensing is initially introduced is compared with with the deterioration voltages Vs2, Vs3, Vs4, Vs5, and Vs6 of the adjacent pixels in sensing the deterioration voltages of the plurality of pixels, the deterioration voltage Vs1 of the pixel into which the current for deterioration sensing is first introduced is sensed as an absolute value of, while the deterioration voltages Vs2, Vs3, Vs4, Vs5, and Vs6 of the adjacent pixels may be sensed as relative values to the determination voltages of the corresponding previous pixels as the adjacent pixels previously receive the sensing current from the previous pixels. Therefore, the analog-digital converter 140 may vary resolution with respect to the sensed voltages of the pixel into which the sensing current is initially introduced and the sensed voltages of the adjacent pixels, and as a result, the sampling rate of the analog-digital converter 140 may be increased.

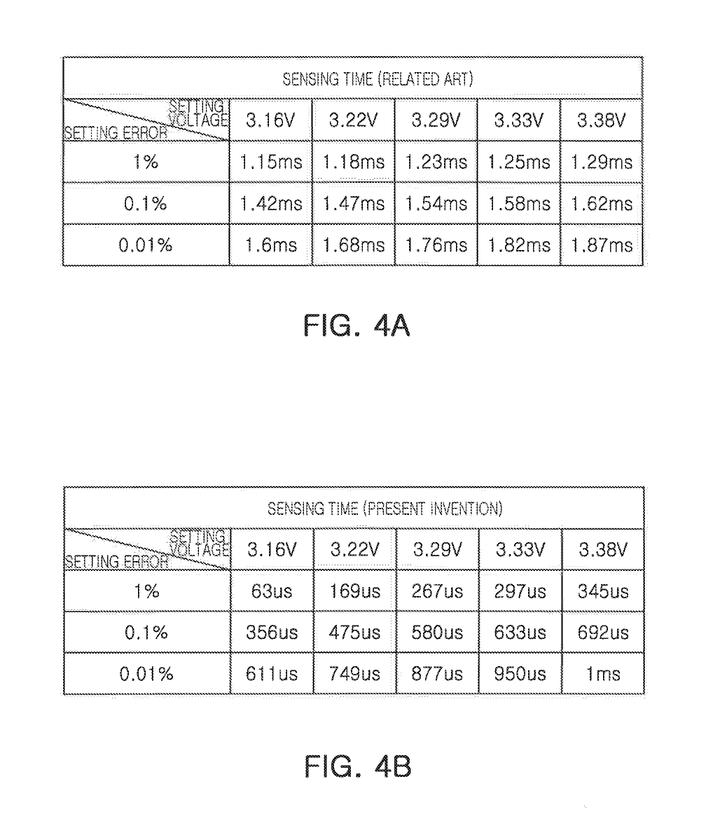

FIG. 4A is a table showing a sensing time of a deterioration sensing apparatus according to the related art and FIG. 4B is a table showing a sensing time of the deterioration sensing apparatus according to the exemplary embodiment of the present invention.

Referring to FIGS. 4A and 4B, the deterioration sensing apparatus according to the exemplary embodiment of the present invention previously transfers the sensing current to the next pixel of a corresponding pixel group and detects the relative deterioration voltage. Thus, it can be appreciated that the sensing time is reduced to approximately ½ or less and in particular, may be reduced to approximately ¼ or less when the voltage error of 1% is recognized, as compared with the related art in which the deterioration of pixels is sequentially sensed by transferring the sensing current to the pixels.

As set forth above, according to exemplary embodiments of the present invention, the determination of a single pixel as sensed for a display device having a plurality of pixels, in particular, an organic light emitting diode panel, while pre-charging a sensing current to an adjacent pixel thereto, such that the deterioration of the pixels can be rapidly sensed.

While the present invention has been shown and described in connection with the exemplary embodiments, it will be apparent to those skilled in the art that modification and variation can be made without departing from the spirit and scope of the invention as defined by the appended claims.

What is claimed is:

1. A deterioration sensing apparatus for a display device, comprising:
a power supply unit transferring a preset current for deterioration sensing:
a pixel unit including a plurality of pixel groups adjacent to each other, each of the plurality of pixel units receiving the current for deterioration sensing from the power supply unit;
a transfer unit including a plurality of switch groups corresponding to each of the plurality of pixel groups, and transferring the current for deterioration sensing from the power supply unit to each pixel group of the plurality of pixel groups to sequentially sense a voltage, wherein, while transferring the current for deterioration sensing to a corresponding pixel group of the plurality of pixel groups to thereby sense a voltage, the transfer unit previously transfers the current for deterioration sensing to a next pixel group adjacent to the corresponding pixel group; and
an analog-digital converter sequentially detecting the voltage of the pixel groups receiving the current for deterioration sensing among the plurality of pixel groups in the pixel unit, and converting the voltage into a digital signal.

2. The deterioration sensing apparatus of claim 1, wherein each of the plurality of pixel groups has a red pixel, a green pixel, and a blue pixel.

3. The deterioration sensing apparatus of claim 2, wherein the transfer unit previously transfers the current for deterioration sensing, being transferred to the corresponding pixel unit of the plurality of pixel units, to a pixel of the red, green and blue pixels of the next pixel group having the same color as a pixel of the red, green and blue pixels of the corresponding pixel group being supplied with the current for deterioration sensing therethrough.

4. The deterioration sensing apparatus of claim 3, wherein each of the plurality of switch groups of the transfer unit includes a plurality of switches transferring the current for deterioration sensing from the power supply unit to a corresponding pixel of the red, green and blue pixels of the corresponding pixel unit, and previously transferring the current for deterioration sensing to the pixel of the next pixel group having the same color as the pixel of the corresponding pixel group.

5. The deterioration sensing apparatus of claim 1, wherein the analog-digital converter converts the voltage of a pixel group of the plurality of pixel groups, initially supplied with the current for deterioration sensing through the transfer unit, into a digital signal, and converts a voltage difference between a pixel group, supplied with the current for deterioration sensing after the pixel unit initially supplied with the current for deterioration sensing among the plurality of pixel groups, and the previous pixel group thereof into a digital signal.

6. The deterioration sensing apparatus of claim 1, wherein the transfer unit previously transfers the current for deterioration sensing to the pixel group adjacent to the corresponding pixel group being supplied with the current for deterioration sensing therethrough, and then, charges or discharges the current for deterioration sensing to the adjacent pixel group.

7. The deterioration sensing apparatus of claim 2, wherein each of the red, green and blue pixels is configured of an organic light emitting diode.
